(19) United States
(12) Patent Application Publication
(10) Pub. No.: US 2012/0078669 A1
(43) Pub. Date: Mar. 29, 2012

(54) COMPUTER-ASSISTED DATA COLLECTION, ORGANIZATION AND ANALYSIS SYSTEM

(75) Inventors: Kevin D. Harkins, McLean, VA (US); Keith G. Curran, North Bethesda, MD (US); K. Kyle Moore, Plainfield, CT (US); James Sweet, Gales Ferry, CT (US); Kymberly J. Maxham, North Bethesda, MD (US); Lauren Abell, Edgewater, MD (US)

(73) Assignee: HARKCON, INC., McLean, VA (US)

(21) Appl. No.: 13/187,320

(22) Filed: Jul. 20, 2011

Related U.S. Application Data
(60) Provisional application No. 61/365,781, filed on Jul. 20, 2010.

(51) Int. Cl. G06Q 10/06

(52) U.S. Cl. 705/7.11

(57) ABSTRACT

A work information system includes a user interface; an analysis system connected to the user interface, the analysis system comprising a plurality of analysis modules including an interactively-developed analysis module; a self-learning database connected to the analysis system; a solution development and design system connected to the self-learning database, where the solution development and design system includes modules for generating reports reflecting skills/knowledge; performance capacity; motivation self-concept; expectation/feedback; tools/processes; and rewards/motivation/incentive; an implementation system connected to the solution development and design system, the implementation system including modules for training; job aids; toolbox; policy; procedures; and a user defined module; an evaluation system; and a feedback system connecting each of the evaluation system, implementation system, solution design and development system, self-learning database, and analysis system to all precedent systems in the work information system.

### CROSS REFERENCE TO RELATED APPLICATIONS

This application claims the benefit of Provisional U.S. Patent Application No. 61/365,781, filed Jul. 20, 2010, the entirety of which is incorporated herein by reference.

### BACKGROUND

In a wide variety of circumstances, there exists a need for a system of organizing and analyzing various types of data that may be collected from various sources. An example of such circumstances is when an organization such as a business organization wishes to start a new line of business. Such a process involves a wide variety of related information that must be collected from an equally wide variety of sources. For example, in order to staff its new business line, the organization must first define the jobs to be performed in that business line, along with the knowledge, skills, and abilities required for each job. Furthermore, the organization may wish to define levels of those knowledge, skills, and abilities that are desirable for a variety of related job performance requirements and job evaluation criteria. Also, the business organization may wish to define competencies associated with the knowledge, skills, and abilities for each job, as well as with the job performance requirements and job evaluation criteria. The business organization will also need to determine how many people are needed to perform each job that is identified through this process, which may require the collection of information from other business lines within the organization, or from other business organizations, or from sources outside the business organization.

It is therefore an object of the present invention to provide a useful analysis tool to provide means for identifying, collecting, quantifying, organizing, and reporting such data. Furthermore, each one of the different data to be collected might have different relative value.

### SUMMARY

The present invention meets the needs identified in the example by providing, in one implementation, a flexible, integrated, systemic and systematic self-learning performance improvement system employing existing and novel tools, tactics, technologies and procedures. In a preferred embodiment, the invention includes a computer-aided system and method for organizing and analyzing work, workplace and worker performance issues at the organization, unit and individual levels manpower, workload and competency data. For every set of data, the present invention provides multiple means for collecting the data, including such techniques as manual data entry, data conversion from pre-existing data sources, and real-time data collection from concurrently operating computer-based systems. The present invention permits a user to define constraints for each of the data that are to be collected, from narrow constraints that limit data, to broad constraints that expand data collection.

The present invention provides an innovative, web-enabled analytic tool designed to ease and organize the data collection and analysis processes. The invention includes a logical and professional user interface to ease its use by analysts and to enable users to manipulate and process data in a small fraction of the time any “by-hand” method takes. In the preferred embodiment, the tool is built on a flexible software platform so that data collection and analysis activities can be conducted far and wide by multiple analysts, with the data synching almost instantaneously on any servers where the software resides or is accessed.

The present invention addresses organizational and workforce performance issues through proven human performance technologies:

Organizational Needs Assessments, that focus on:
Identifying desired outcomes based on capstone documents such as mission, vision, and strategic goals;
Comparing desired outcomes to the current state to determine gaps at the organization, work unit, and/or individual levels;
Identifying root causes for each gap; and
Identifying potential solution sets for addressing those root causes

Manpower Requirements Analyses;

Front End Analyses;

Job Task Analyses;

Cost Benefit Analyses; and

Survey Development and Deployment

Furthermore, the present invention includes feedback mechanisms to reorganize and reanalyze automatically as data are added to the system. Data can be collected in real time, through linked sources such as computer-assisted systems, telephones, modems, keyboards, microphones, and any other available data collection apparatus. In part through the feedback process, the present invention can acquire artificial intelligence capabilities, through which the invention can create predictive models and improve the efficiency of its own operations.

The present invention includes a user interface that can be synchronized with multiple users and also with multiple data collection systems and user inputs, such as data constraints. The present invention also includes an output that permits the production of reports and the delivery of instructions. The reports and instructions produced by the output may be used to interface with other systems, as well as providing information regarding the results of the collection, organization, and analysis of data conducted by the system.

The present invention includes a process of surveying an organization's mission, vision, and values, as well as strategic and business goals to gain an understanding of where the organization is and where the organization wants to be.

Subsequently, the present invention may assist and guide an in-depth analysis of the processes and procedures already in place, a review of organizational structure, identification on environmental influences (both internal and external), and identification of key suppliers and customers of the organization. The present invention may also include processes to analyze the workplace, including office layouts, workspace configuration, and any equipment, tools, hardware, and software that the organization may use. At the same time, the invention may include a process for establishing benchmarks of other high performing businesses and organizations for comparison with the analyzed business organization.

This in-depth analysis process of the present invention enables the organization to identify any gaps between its status quo and its goal status, across all levels of the organization. Furthermore, the invention may include processes for identifying root causes for why identified gaps exist. Determining the root causes enables the present invention to be used to identify the most cost-effective and highest quality recommended set of solutions for helping an organization effectively meet its mission, vision, and goals.

The present invention adapts to a world of work that constantly changes, including changes to an organization's human capital requirements. The invention includes Manpower Requirements Analysis, that can be conducted across all levels of an organization and across all work components, to address the fact that at any given point, the number and type of employees an organization need are changing based on the strategies employed to meet the organization's business goals. The Manpower Requirements Analysis of the present invention includes processes to determine what needs to be done, as well as determine what kind of workers, or how many of them, the organization needs to accomplish its business objectives. The Manpower Requirements Analysis provides a verifiable way to collect, measure, and analyze the human capital needed to achieve an organization's mission, vision, and goals. Thus the Manpower Requirements Analysis permits evaluation of personnel requirements based on a common set of standards and analytical approaches.

For any type of work organization, the present invention can assist an organization to
Determine how much work there is;
Determine who needs to do the work;
Determine how many workers are needed; and
Provide the organization with viable options documenting the number and type of workers needed to accomplish the identified and analyzed work.

Data from the Manpower Requirements Analysis may be used by an organization to define its
Workforce planning, forecasting, and recruiting needs by identifying how many and what type of employees are needed;
Training needs by identifying the quantities of needed competencies; and
Development and promotion systems by providing a better understanding of the labor categories and pay bands need to complete the organization's work.

Further, the present invention includes Front End Analysis (FEA) to provide a link between performance gaps and appropriate interventions at the worker level. Just as with performance problems at the organizational level, attempts to resolve performance problems at the individual worker level often fail to achieve their intended goals because identified solutions are designed to treat only visible symptoms rather than underlying causes. When the root causes of a problem are uncovered and gaps reduced or eliminated through the FEA process, the probability of eliminating problems is greatly enhanced. The processes included in the present invention for conducting FEAs directly ties an organization's work to improved performance by determining the effective design of solutions most appropriate for each specific situation.

The present invention may also include processes for conducting a combination of expert performer interviews and direct observation of how they do their work, further to complete an analysis of the world of work for a work organization. The software data analysis tool of the present invention performs these tasks and processes quickly and effectively, enabling an organization to design and develop customized solutions to distribute the special tools and tactics of the expert performers to an entire workforce through Electronic Performance Support Systems (EPSSs), job aids, training, and e-learning blended solutions.

The present invention may also provide an organization with solutions sets that include environmental performance supports such as work design, policy and technical manual updates and information technology improvements; motivation/incentive supports such as revised pay and benefit packages; and/or assignment/selection performance supports such as competency-specific position descriptions.

In a specific embodiment of an aspect of the invention, a competency module enables an organization to directly link its workforce to its organizational goals and outcomes through customized personnel selection criteria including defined competencies, performance evaluations, career development plans, and training. These and other features, aspects, and advantages of the present invention will become better understood with reference to the following description and claims.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 is a diagram of an exemplary environment in which systems and methods, described herein, may be implemented;

FIG. 2 is a diagram of an exemplary embodiment of the invention; and

FIG. 3 is a diagram of a Work Breakdown Structure used in an aspect of an exemplary embodiment the invention.

### DETAILED DESCRIPTION OF EMBODIMENTS OF THE INVENTION

The following detailed description refers to the accompanying drawings. The same reference numbers in different drawings may identify the same or similar elements.

### Overview

Implementations, described herein, may facilitate a data organization and analysis system. These implementations will be described in terms of a human resources management environment, though the description may apply to other information-intensive environments, including all manner of industrial, commercial, or personal activities.

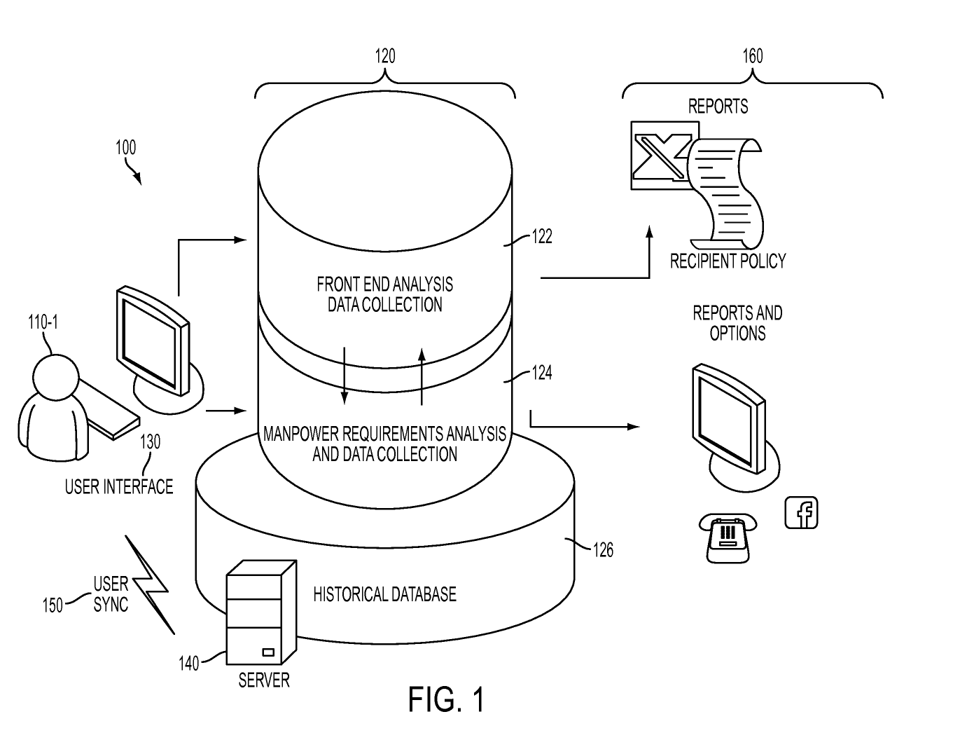

FIG. 1 is a diagram of an exemplary work information environment 100 in which systems and methods, described herein, may be implemented. Environment 100 may include multiple users 110-1, . . . , 110-M (where M>1) (referred to collectively as “clients 110,” and individually as “client 110”) each connected to a data management system 120 through a user interface 130. In the embodiment shown in FIG. 1, data management system 120 includes a Front End Analysis component 122, a Manpower Requirements Analysis and Data Collection component 124, and an Historical Database component 126. In a preferred embodiment, Front End Analysis component 122, Manpower Requirements Analysis and Data Collection component 124, and the Historical Database component 126 are resident on a computer server device 140. Multiple users 110 may access all components of the data management system 120, and through the user interface 130 may access, add, delete, edit, and analyze data in data management system 120. Activity by multiple users 110 is synchronized by user sync 150, which is connected to each user 110 and to data management system 120, typically through server 140. The exemplary workplace environment 100 also includes a variety of output 160. Output 160 may include printed reports, visual displays, telephone announcements, social media communication, or any other output suitable for the specific work information environment 100. The information conveyed through the output 160 may be any combination of information from the Front End Analysis component 122, Manpower Requirements Analysis and Data Collection component 124, and Historical Database component 126 of data management system 120.

User interface 130 may be any suitable mechanism for information access and entry. Typically, as shown in FIG. 1, user interface 130 will include some variety of personal computer, most commonly networked. However, virtually all other available forms of data transmission may be used, including telephone, written information input such as forms, wireless digital devices such as iPods, iPads and computer tablets, or cell telecommunication devices. While FIG. 1 shows a particular number and arrangement of devices, environment 100 may include additional, fewer, different, and/or differently arranged devices in other implementations.

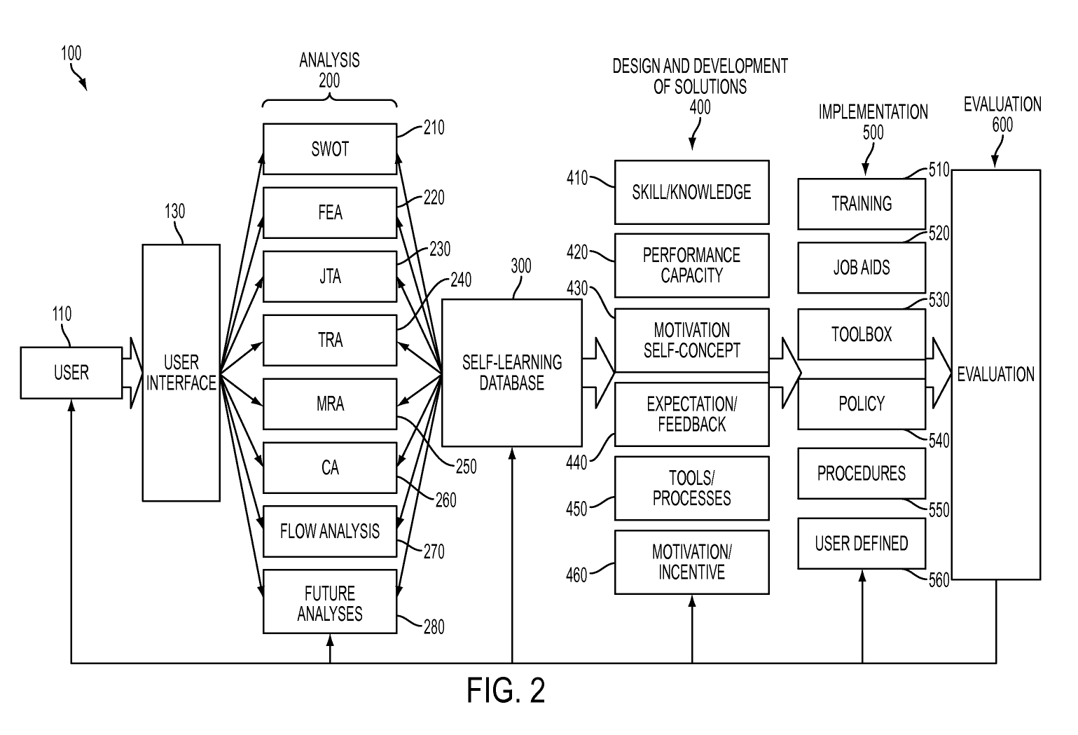

FIG. 2 is a diagram illustrating a detailed example of the information processes used in work information environment 100 of the present invention. In the exemplary embodiment shown, multiple users 110 connect through user interface 130 to Analysis System 200. User Interface 130 is designed in the exemplary embodiment to help each user 110 identify, select and access different types of analytical techniques based on the organizational work, workplace or worker needs of each respective user 110. User interface 130 permits each user 110 to enter data obtained through multiple sources including data review, surveys, interviews, or focus group processes.

Analysis System 200 includes a system for assisting each user 110 to organize data into appropriate data fields through any method permitted by user interface 130, including user key-stroke entry, check-box selection, and pull-down menu selection. As the work information environment 100 database grows, Analysis System 200 permits users 110 to modify, and/or select previously entered information. Analysis System 200 links to Self-Learning Database System 300, which is connected to Solution Development and Design System 400, Implementation System 500, and Evaluation System 600.

According to the exemplary embodiment shown in FIG. 2, information analyzed in work information environment 100 is categorized as a combination of work data, workplace data, and worker data. Work data include strategic goals; business goals; work processes; doctrine; and work procedures. Workplace data include human resources and other workplace policies; physical environment descriptions; equipment; tools; hardware; and software. Worker data include job descriptions; personnel selection criteria; required competencies; Tactics, Techniques and Procedures (TTP); and performance criteria.

Electronic Performance Support Job aids are integral to the work information environment 100 and in some cases, in the embodiment shown in FIG. 2, data entry is limited to acceptable entries. Internal reporting features are included to aid the user to view status, progress and or interim results of the data entry process. Data is then automatically accessed and interpreted based on the analytical technique selected to best meet the needs of each individual user 110.

Analysis System 200 includes a series of modules for focused information analysis, including SWOT module 210, FEA module 220, JTA module 230, TRA module 240, CA module 260, Flow Analysis Module 270, and Future Analyses module 280. Each of the modules in Analysis System 200 is intended to receive input or data manipulation from the user 110 through user interface 130.

SWOT module 210 receives, analyzes, and outputs information related to Strengths, Weaknesses, Opportunity and Threats Analysis. FEA module 220 receives, analyzes, and outputs information related to Front End Analysis. JTA module 230 receives, analyzes, and outputs information related to Job Task Analysis. TRA module 240 Training Requirements Analysis. MRA module 250 receives, analyzes, and outputs information related to Manpower Requirements Analysis. CA module 260 receives, analyzes, and outputs information related to Competency Analysis. Flow Analysis Module 270 receives, analyzes, and outputs information related to flow analysis, i.e. the analysis of tasks and/or steps in a particular process and the throughput of a product through those tasks/steps using such techniques as those found in industrial engineering. Future Analyses module 280 permits analytical techniques to be developed, improved, and implemented interactively through the operation of Analysis System 200, Self-Learning Database System 300, Solution Development and Design System 400, Implementation System 500, and Evaluation System 600, as well as through feedback from each of those systems.

In the embodiment shown in FIG. 2, Self Learning Database 300 is specifically designed to allow each user 110 to access the most up to date information available for a work organization with information related to work information environment 100. In practice, data management system 120 includes a dynamic store of information such that the user interface 130 presents targeted information, automatically populating the user's interface based on the organization and analytical methodology module (e.g. SWOT module 210, FEA module 220, JTA module 230, TRA module 240, or CA module 260) selected by user 110. Each time any user 110 from any organization accesses work information environment 100, data for that user's organization is automatically updated and available. Self-Learning Database 300 thus allows for scalability of analyses from different organizational levels for every user 110: organization, department and individual worker. As organizational data increases, Self-Learning Database 300 also permits and conducts interpolation and extrapolation between any organization's levels for any user 110 from any organization. For example, data collected for widget-line workers in Wichita may be used to form the basis for an analysis of the entire Wichita widget plant, or the widget-line workers in Walla Walla Wash. Self-Learning Database 300 also enables data to be used in other analyses desired by the organization. For example an FEA or JTA of widget-line workers to describe the world of work will form the basis for a MRA to determine how many workers are needed to meet organizational goals. In another example, data collected for such units as administrative staffs or accounting staffs at the Wichita widget plant could be used in other analyses involving administrative staff or accounting staff in other industries. After multiple analyses of administrative staffs or accounting staffs, performance improvement systems, such as a certification system for such staffs and/or jobs could be created.

Solution Development and Design System 400 of the embodiment shown in FIG. 2 is arranged to design and develop work interventions. To this end, Solution Development and Design System 400 includes a variety of interactive report generator modules automatically created from the Self-Learning Database 300, to support the design and development of performance interventions in order to improve the performance of the any organization, department or individual. In the embodiment shown in FIG. 2, the report generator modules of Solution Development and Design System 400 focus on 6 areas of performance improvement, and include Skill/Knowledge report generator module 410, Performance Capacity report generator module 420, Motivation/Self-Concept report generator module 430, Expectation/Feedback report generator module 440, Tools/Processes report generator module 450, and Rewards/Motivation/Incentive report generator module 460. Each report generator module generates reports including recommendations that are based on and supported by the data collected and stored in Self-Learning Database 300.

In the embodiment shown in FIG. 2, Implementation System 500 includes any of several implementation modules that form the basis of and support for organizational investment for performance improvement. Implementation modules include Training module 510; Job Aids module 520; Toolbox module 530; Policy module 540; Procedures module 550, and User-defined module 560.

An exemplary implementation of Toolbox module 530 is a Competency Toolbox, which uses a client-facing interface supported by data derived from one or more analyses and stored in Self Learning Database 300, to provide organizations with a competency-based system to attract, hire, develop, evaluate, and retain employees. The competency toolbox is disclosed in commonly assigned United States Patent Application Publication No. US 2010/0138474, and is incorporated herein by reference.

The embodiment shown in FIG. 2 includes Evaluation System 600. Based on the performance of interventions selected in Solution Development and Design System 400, Evaluation System 600 provides the ability to focus quickly on those areas of performance that are still not performing to organizational goals/requirements, or allows the company to specifically identify the best performing interventions for application to other parts of the organization. This especially applies when considering worker level performance interventions.

As further shown in FIG. 2, each system element of work information environment has interactive feedback loops with each of the other system elements. Thus, Evaluation System 600 provides feedback to any or all of Implementation System 500, Solution Development and Design System 400, Self-Learning Database System 300, Analysis System 200, and user 110. Similarly, Implementation System 500 provides feedback to Solution Development and Design System 400, Self-Learning Database System 300, Analysis System 200, and user 110. In like fashion, each of Solution Development and Design System 400, Self-Learning Database System 300, and Analysis System 200 provides feedback to any and all precedent sources of information in work information environment 100, and to user 110. This interactive feedback is systematically incorporated into the self-learning database, leading to systemic improvement in each of the systems and modules in work information environment 100. In every case where interactive and automatic transfer of data is described, the embodiment shown in FIG. 2 also includes means for manual access to editing of, input, and removal of data, through any of the user interfaces included in the system.

### Exemplary Human Resources Mode

An example of one aspect—in particular, the Competency Analysis Module—of the above description is evident in the field of human resource management. For instance, a business organization may wish to fill a job that has been identified and defined for a new business line. In the simplest of cases, the new job would be in the same location as the manager who will make the hiring decision, such as in an office where a manager might hire staff who reports directly to him. However, this simple hiring decision is immediately complicated in a variety of ways, since any or all of the following considerations might be relevant:
availability of job candidates;
number of job candidates willing to apply;
education levels of candidates who apply;
relevant experience of candidates who apply.

As an example, in one case a highly educated candidate might be more valuable than an experienced candidate, whereas in a different case the experienced candidate might be more valuable. In addition, the data collected from one person might be more valuable than the data collected from another person. Similarly, the value of each candidate attribute might vary for the same job, depending on other data such as mean education level in a given work unit, or mean experience in a given work unit.

Furthermore, each of the relevant considerations might have many different variables. For example, the availability of job candidates might be affected by such variables as advertising the vacancy, and there are a variety of methods for advertising a job vacancy. Such methods might include physically posting a sign at the job location such as “help wanted—inquire within;” advertising the job vacancy through word of mouth; or advertising the position in print; online, or in various other media including radio and television. Thus, even the simplest of analyses—in this case, a simple human resources decision—can become complicated by multiple data sources providing multiple types of data.

The Competency Analysis Module of the present invention is designed to help those involved in all aspects of hiring, supervising and leading new employees by making those processes easier. By using competencies derived from an analysis of a job, position, specialty, and other job-related data, one can create (design and develop) a series of standard tools (interventions) to help an employer attract, select, hire, develop, evaluate, reward and retain an employee.

In this specific application of the Competency Analysis Module in a human resources implementation, the work information environment shown in FIG. 2 may include the following types of data:

Full Performance Analysis and Intervention Development Support, including:
Analysis of an organization's Work;
Analysis of an organization's Workplace;
Analysis of an organization's Workforce (e.g. Competency Identification);
Training Design, Development & Implementation;
Motivation/Incentive Support;
Environmental/Tools/Equipment Support;
Job Selection Support (e.g. the Competency Toolbox);

Work, Workplace, Worker Analysis Tool w/ support for internal consultants;

Competency Toolbox, including
Attracting and hiring the right person the first time;
   a. Performance Based job descriptions;
   b. Job Announcements; and
   c. Interview Guide;
Communicating job objectives in measurable terms and developing employees in exactly the areas needed; e.g.
   a. Individual Development Plan (Based on gap analysis between competencies at hiring & needed competencies);
   b. Performance Based Evaluation Tool;
   c. Individualized Incentive & Benefit Programs;
   d. Organization and Operating Manuals;
Developing employees by utilizing specifically designed performance interventions; e.g.
   a. Coaching Program
   b. Job Aids
   c. Resource Guides
   d. On-site and Web-based training

Building organization-wide and/or industry-wide certification assessment program; e.g.
Competency-based Job Certification Program;
   For example, a competency-based Job Certification Program combines organizationally identified competencies to form certifications/qualifications program aligned with organizational requirements. These competencies/certifications/qualifications are captured for mission needs (demand) and every employee's competencies are recorded and maintained. An organization can then identify gaps and overlaps by tracking the rate at which competencies and/or certifications and/or qualifications are acquired (e.g. through accessions, individual development, assignments, evaluations and promotions) and the rate at which competencies are lost (e.g. through attrition and separations). The organization may also identify requirements and costs for new missions. Such a result could be a primary and unifying focus of all HR Management activities.

### Example

The following example describes the principles of the work information system of the present invention applied by a specific organization in a specific task. In this example, assume that a large maritime organization has determined that they need to analyze the roles of the Yeoman (YN) rating serving in the organization's Servicing Personnel Offices (SPO) and Personnel and Administration (P&A) offices. Assume further that the maritime organization contracts people to serve in the Yeoman rating in either an active duty status or reserve status. Furthermore, the maritime organization may contract with auxiliary personnel to serve in the Yeoman rating.

Combined, the Servicing Personnel Offices and Personnel and Administration Offices serve as the maritime organization's direct representative to active duty, reserve, and in some cases auxiliary personnel, for pay and personnel issues, and those two offices also are ultimately responsible for the accurate and timely processing of a large number of pay and personnel transactions annually and maintaining a record of those transactions. Their role in the flow of information makes them a critical piece in the maritime organization's goal of transforming the maritime organization's financial organization into a model of excellence capable of sustainable clean audit opinion, while supporting mission execution. Fully understanding the roles, reporting relationships and requirements of SPO and P&A offices and those people serving in the SPO and P&A offices are critical for maintaining and improving the delivery of Human Resource (HR) services.

The New Performance Planning Front-End Analyses (NPP-FEAs) of the YN workforce address unit and individual level performance requirements as they relate to the position, or rating, of Yeoman (YN). NPP-FEA:
Describe performance;
Determine inhibitors to competent performance;
Recommend performance interventions that must be put in place to help a worker in that position achieve optimum performance; and
Identify the competencies required of that worker to perform in that position.

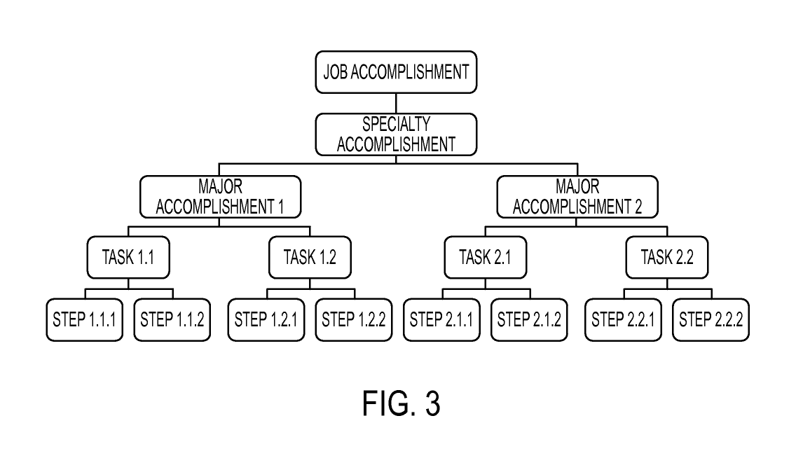

The YN world of work can be broken down as shown in the Work Breakdown Structure diagram shown in FIG. 3, and data may be collected using the work depicted: Data collected may include major accomplishments (MA), tasks and steps; and specific information about those MAs and tasks including difficulty, interval, frequency, importance, stimulus, criteria, output, and positive/negative influences, tools, etc.

Due to the size of the data in this exemplary application, (approximately 100 MAs, 500 tasks and several thousand steps), the following example is limited to one MA and the associated tasks.

MA: Member in maritime organization

Tasks:
1. Obtain new accession documentation;
2. Assist new accession complete documentation;
3. Process prior service documentation;
4. Complete accession transaction for a hire;
5. Approve accession transaction for a hire;
6. Complete accession transaction for a rehire;
7. Approve accession transaction for a rehire;
8. Correct errors; and
9. Complete post hire processing.

Steps for the first task “Obtain new accession documentation” are:
1. Obtain original orders
2. Obtain copy of social security card;
3. Obtain copy of drivers license;
4. Obtain copy of birth certificate;
5. Obtain proof of residency status or naturalization;
6. Obtain copy of enlistment/reenlistment document;
7. Obtain copy of OCS agreement;
8. Obtain copy of certificate of release or discharge from active duty;
9. Obtain copy of conditional release from other service;
10. Obtain documentary evidence of dependents;
11. Obtain copy of report of medical examination;
12. Obtain copy of report of medical history;
13. Obtain copy of immunization record; and
14. Obtain copy of college transcripts.

Information collected for this task and stored in the work information system may include (but is not limited to):
1. Reference documents, e.g. maritime organization recruiting manual, Pay & Personnel Center Servicing Personnel Office (SPO) Manual;
2. Stimulus—Receive packet from Recruiter, message from epm, or on airport terminal;
3. Task Output—Documentation to start accession process;
4. Critical Aspects—Access to all the documents in the document package; marriage certificate, birth certificates and SSN cards if applicable must be certified copies; and
5. Criteria—An accession transaction is required when:
   a. First becomes a member of the maritime organization or maritime organization Reserve;
   b. Who was a member of the maritime organization (active or reserve) rejoins the maritime organization (active or reserve) following a break in service of more than 24 hours;
   c. Is discharged from the maritime organization (active duty) and immediately enlists in the maritime organization Reserve;
   d. Who is a member of the regular maritime organization or maritime organization Reserve receives a direct commission as an officer (other than CWO) through other than attendance of Officer Candidate School (OCS) or Reserve Officer Candidate Indoctrination (ROCI);
   e. Is discharged from the maritime organization Reserve and immediately enlists in the maritime organization (active duty). Note that any accession of a person currently serving in the maritime organization or maritime organization reserve must be immediately preceded by a discharge from that component before the member can be accessed into the other component;
6. Environment—Office;
7. Hazards, Cautions, Tools, and Equipment—Computer; phone; mail; email; printer, copier; scanner; fax; Employment Contract Documentation; Certificate of Release or Discharge from Active employment; Report of Medical Examination; Report of Medical History;
8. Positive Influences—Complete package; Responsive recruiter; Timeliness of document delivery; Experience; Knowledge; Job aids and procedures already available; Proper documentation; Member cooperation/availability; Dedicated workday hours to perform; Adequate staffing; Good management; Member's knowledge of responsibilities/ownership;
9. Negative Influences—Incomplete package; Difficult to communicate with recruiter; Complexity of obtaining documents; Often have to rely on others; Lack of access to member; Time conflicts; Interruptions; Lack of training; Procedural guidance vs. policy issues (no definitive standard); Unreasonable member expectation; Prioritization affected by OPTEMPO; Outdated manuals/guidance; Lack of access to data or information; Task interference/conflicting priorities; Absence of or poor feedback; Requirements not consistent; Lack of human resources

Root Causes and Intervention Recommendations may be developed based on the FEA:

| Root Cause | |
|---|---|
| Classification | Intervention Recommendations |
| Lack of knowledge, | Create, fund, and mandate YN “C” schools that include intermediate and |
| skills or information | advanced Direct Access (DA) training-form based on |
| | functions/requirements/standards identified |
| | Create, fund, and mandate training to include: counseling techniques, |
| | communications skills, facilitation skills, conflict management resolution, |
| | customer service skills, and coaching skills |
| | Create, deliver and maintain YN PQS program to include functions |
| | requirements/standards identified: e.g. Accessions, Advancements, Assignments, |
| | Separations, Travel, etc. |
| Ineffective workplace | Review, revise, and articulate a standard organizational structure- |
| | accountable for all pay and personnel transactions/records generated-form based |
| | on functions/requirements/standards identified |
| | Identify and describe data flow/data entry for pay and personnel processes |
| | Review, revise, and standardize pay & personnel processes-resolve |
| | conflicting guidance from multiple sources and recognize as policy vice |
| | procedural guidance |
| | Identify required information/documentation necessary for all pay and |
| | personnel transcations-source/working documents |
| | Identify and implement a process to store & retrieve required |
| | information/documentation necessary for all pay & personnel transactions- |
| | source/working documents |
| | Develop and implement a process to verify accuracy/validity of required |
| | information/documentation collected and entered into database-centralized data |
| | record integrity function |
| | Enhance connectivity of database to end user-provide availability of |
| | reliable computer/web access/connectivity to systems |
| | Create web-based IPDR-make this the only required record |
| | Derive and apply collateral duty staffing standard-account for collateral |
| | duties in workload/manpower determinations |
| Lack of motivation or | Create, articulate and enforce policies that address lessons learned and |
| incentive | feedback received from previous audits-clarify which specific transactions |
| | require increased internal controls to satisfy audit requirements |
| | Develop a YN career development plan/program-include specific |
| | professional development opportunities |
| Improper assignment/ | Establish and resource YN staffing standards based on primary/collateral |
| selection | duty functions/requirements/standards identified |
| | Establish a YN/PERS competency system-articulate and track YN |
| | competencies and minimum proficiency standards |
| | Create and implement a YN credentialing and/or cerification program |
| | Recognize, resource and formally integrate auditing positions |

The results of the FEA may be used to develop an analytically derived and supported system of competencies that link identified organization-level strategic objectives to the world of work performed by the YN rating. The proposed system directly affect several interventions identified in the YN MRA Performance Intervention Selection process, integrate with existing YN Enlisted Performance Qualifications (EPQ), and give the maritime organization a competency-based structure to identify, assess, prioritize and monitor the progress of their efforts to support the HR and Payroll MAP

| Rank/ | | | |
|---|---|---|---|
| Specialty | E-3 to E-6 | E-5 to E-7 | E-7 to CWO |
| ACC | | | |
| | Accession Documentation | Accession Management | |
| | Processing | | |
| | Prior Service Determination | | |
| | Accession Transactions | | |

| Competency | Competency Description | Qualification Requirements |
|---|---|---|
| Accession | Skill and ability to manage completion | Completion of Accession |
| Management | and approval of documentation and | Documentation Processing, Prior |
| | transactions to effect successful | Service Determination, and |
| | accession of personnel into the | Accession Transactions PQS |
| | Service. | sections; successful performance in |
| | | managing included tasks for a |
| | | period of a year; and approval of |
| | | Div/Dept Head |
| Accession | Ability to complete accession | Completion of applicable PQS |
| Transactions | processing transactions including hire, | section and approval of Supervisor |
| | rehire and post hire, and error | |
| | correction procedures. | |
| Prior Service | Knowledge and ability to perform | Completion of applicable PQS |
| Determination | prior service determinations including | section and approval of Supervisor |
| | request and validation of Statements of | |
| | Creditable Service and Creditable Sea | |
| | Service (SOCS, SOCSS), and member | |
| | counseling of the same. | |

The results of the FEA may be used to analyze unit-level workflow and identify unit level financial management functions. For example, based on the premise that form follows function, the work information system may assist the drafting of a proposal for an alternative organizational structure.

In the example, the maritime organization may also want to conduct a Manpower Requirements Analysis (MRA) to determine the number and types of people, and the competencies each requires to perform that work identified in the NPP-FEA. The goal of an MRA would thus be to inform decision makers what work needs to be accomplished to meet the mission, and program managers the information necessary to define the right mix of positions to perform that work; effectively translating mission requirements into manpower requirements.

| | | | | Workload per | Workload Finished |
|---|---|---|---|---|---|
| | | Work | Count | Occurrence | (Hours completed |
| Work ID | Work Title | Frequency | (in org) | (In hours) | per week) |
| YN.ACC01.T01 | Obtain new accession | Yearly | 4,945.00 | 2.61 | 279.06 |
| | documentation | | | | |
| YN.ACC01.T02 | Assist new accession | Yearly | 4,945.00 | 1.82 | 194.94 |
| | complete documentation | | | | |
| YN.ACC01.T03 | Process prior service | Yearly | 784.00 | 2.08 | 35.27 |
| | determination | | | | |
| YN.ACC01.T04 | Complete accession | Yearly | 3,462.00 | 2.54 | 190.74 |
| | transaction for a hire | | | | |
| YN.ACC01.T05 | Approve accession | Yearly | 3,462.00 | 2.40 | 180.03 |
| | transaction for a hire | | | | |
| YN.ACC01.T06 | Complete accession | Yearly | 1,484.00 | 2.40 | 77.22 |
| | transaction for a rehire | | | | |
| YN.ACC01.T07 | Approve accession | Yearly | 1,484.00 | 1.54 | 49.63 |
| | transaction for a rehire | | | | |
| YN.ACC01.T08 | Correct errors | Yearly | 48.00 | 1.29 | 1.34 |
| YN.ACC01.T09 | Complete post hire | Yearly | 4,945.00 | 1.84 | 197.09 |
| | processing | | | | |

Integration of the Front End Analysis information with that of the Manpower Requirements Analysis will result in the Manpower Requirements Analysis Report. The MRA report will document the number and type of positions (people) needed to accomplish the mission requirements to the mission standard. In addition, it will provide the competencies, training, education, experience, and licensing/certification requirements for each position. This report will provide the Program Manager with the information required to make decisions regarding mission requirements and standards and provide the empirical support necessary to implement MRA interventions including Resource Proposals, Personnel Allowance Amendments and restructuring.

### CONCLUSION

The foregoing description provides illustration and description, but is not intended to be exhaustive or to limit the invention to the precise form disclosed. Modifications and variations are possible in light of the above teachings or may be acquired from practice of the invention.

For example, while series of blocks have been described with regard to FIGS. 1-3, the order of the blocks may be modified in other implementations. Further, non-dependent blocks may be performed in parallel.

Further, while the terms “system” and “module” have been used to refer to devices, these terms may also refer to applications operating on these devices. The term “server device” is intended to refer to a device and not to applications running on the device.

It will be apparent that aspects described herein may be implemented in many different forms of software, firmware, and hardware in the implementations illustrated in the figures. The actual software code or specialized control hardware used to implement these aspects does not limit the embodiments described herein. Thus, the operation and behavior of the aspects were described without reference to the specific software code—it being understood that software and control hardware can be designed to implement the aspects based on the description herein.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed:

1. A work information system comprising:
a user interface;
an analysis system connected to said user interface, the analysis system further comprising at least one of
a strengths, weaknesses, opportunity and threats analysis module;
a front end analysis module;
a job task analysis module;
a training requirements analysis module;
a manpower requirements analysis module;
a competency analysis module;
a flow analysis module; and
an interactively-developed analysis module;
a self-learning database connected to said analysis system;
a solution development and design system connected to said self-learning database, said solution development and design system further comprising at least one of
a skill/knowledge report generator module;
a performance capacity report generator module;
a motivation self-concept report generator module;
an expectation/feedback report generator module;
a tools/processes report generator module; and
a rewards/motivation/incentive report generator module;
an implementation system connected to said solution development and design system, said implementation system including at least one of
a training module;
a job aids module
a toolbox module;
a policy module;
a procedures module; and
a user defined module;
an evaluation system; and
a feedback system connecting each of said evaluation system, implementation system, solution design and development system, self-learning database, and analysis system to all precedent systems in the work information system.

2. The work information system of claim 1, where the toolbox module includes a competency-based human resources management database.

3. The work information system of claim 1 further including a server, where at least one of
the analysis system;
the self-learning database;
the solution development and design system;
the implementation system; and
the evaluation system; is resident on said server.

4. The work information system of claim 3, where the server is connected to a computer network.

5. The work information system of claim 4, where the computer network is connected to the internet.

6. The work information system of claim 5, where the user interface includes a web browser.

7. A method for managing a work information, comprising:
collecting data in at least one analysis module including
a strengths, weaknesses, opportunity and threats analysis module;
a front end analysis module;
a job task analysis module;
a training requirements analysis module;
a manpower requirements analysis module;
a competency analysis module;
a flow analysis module; and
an interactively-developed analysis module;
analyzing said collected data its respective analysis module;
storing said collected data and said analyzed data in a self-learning database;
generating a solution report from said collected analyzed data, where the solution includes at least one of
a skill/knowledge report;
a performance capacity report;
a motivation self-concept report;
an expectation/feedback report;
a tools/processes report; and
a rewards/motivation/incentive report;
implementing at least a portion of said generated solution report, using at least one of
a training module;
a job aids module
a toolbox module;
a policy module;
a procedures module; and
a user defined module; and
evaluating said implemented portion.
